(19) United States
(12) Patent Application Publication
(10) Pub. No.: US 2010/0066718 A1
(43) Pub. Date: Mar. 18, 2010

(54) DRIVING DEVICE AND DRIVING METHOD OF PLASMA DISPLAY PANEL, AND PLASMA DISPLAY DEVICE

(75) Inventors: Masaaki Kuranuki, Kyoto (JP); Toshikazu Nagaki, Osaka (JP); Kazuo Oohira, Osaka (JP)

Correspondence Address: GREENBLUM & BERNSTEIN, P.L.C., 1950 ROLAND CLARKE PLACE, RESTON, VA, 20191, US

(73) Assignee: PANASONIC CORPORATION, Osaka (JP)

(21) Appl. No.: 12/528,478

(22) PCT Filed: Feb. 20, 2008
(86) PCT No.: PCT/JP2008/000281

§ 371 Date: Aug. 25, 2009

(30) Foreign Application Priority Data
Feb. 28, 2007 (JP) 2007-050444

(51) Int. Cl. G09G 5/00

(52) U.S. Cl. 345/212

(57) ABSTRACT

In a driving device of a plasma display panel including switch circuits (Q1, Q2) that selectively connect either a first node (N1) or a second node (N2) to a scan electrode (SC1), a voltage hold circuit (200) that is provided between the first node (N1) and a third node (N3) for holding a voltage between the first node (N1) and the second node (N2) to a first voltage (Vscn), a protection circuit (300) that is provided between the second node (N2) and the third node (N3), and a potential of the first node (N1) being changed, the protection circuit (300) includes a protective resistance (R1), a rectification circuit composed of a capacitor (C1), a charge restriction resistance (R2), and a diode (Da) connected in parallel to the protective resistance (R1), two discharge resistances (R3, R4) connected in parallel to the capacitor (C1), and a transistor (Q10) that generates an abnormality detection signal (SOS) based on a potential of a connection point (N7) of the two discharge resistances (R3, R4).

### TECHNICAL FIELD

The present invention relates to a driving device and a driving method of a plasma display panel and a plasma display device employing the same.

### BACKGROUND ART

An AC surface discharge type panel that is typical as a plasma display panel (hereinafter abbreviated as “a panel”) includes a number of discharge cells between a front plate and a back plate arranged to be opposite to each other.

The front plate is constituted by a front glass substrate, a plurality of display electrodes, a dielectric layer and a protective layer. Each display electrode is composed of a pair of scan electrode and sustain electrode. The plurality of display electrodes are formed in parallel with one another on the front glass substrate, and the dielectric layer and the protective layer are formed so as to cover the display electrodes.

The back plate is constituted by a back glass substrate, a plurality of data electrodes, a dielectric layer, a plurality of barrier ribs and phosphor layers. The plurality of data electrodes are formed in parallel with one another on the back glass substrate, and the dielectric layer is formed so as to cover the data electrodes. The plurality of barrier ribs are formed in parallel with the data electrodes, respectively, on the dielectric layer, and the phosphor layers of R (red), G (green) and B (blue) are formed on a surface of the dielectric layer and side surfaces of the barrier ribs.

The front plate and the back plate are arranged to be opposite to each other such that the display electrodes intersect with the data electrodes in three dimensions, and then sealed. An inside discharge space is filled with a discharge gas. The discharge cells are formed at respective portions at which the display electrodes and the data electrodes are opposite to one another.

In the panel having such a configuration, a gas discharge generates ultraviolet rays, which cause phosphors of R, G and B to be excited and to emit light in each of the discharge cells. Accordingly, color display is performed.

A sub-field method is employed as a method for driving the panel. In the sub-field method, one field period is divided into a plurality of sub-fields, and the discharge cells are caused to emit light or not in the respective sub-fields, so that a gray scale display is performed. Each of the sub-fields has a setup period, a write period and a sustain period.

In the setup period, a setup discharge is performed, and wall charges that are required for a subsequent write operation is formed in each discharge cell. In addition, the setup period has a function of generating priming for reducing a discharge time lag to stably generate a write discharge. Here, the priming means an excited particle that serves as an initiating agent for the discharge.

In the write period, progressive-scan pulses are applied to the scan electrodes while write pulses corresponding to image signals to be displayed are applied to the data electrodes. This selectively generates the write discharges between the scan electrodes and the data electrodes, causing the wall charges to be selectively formed.

In the subsequent sustain period, sustain pulses are applied between the scan electrodes and the sustain electrodes a predetermined number of times corresponding to luminances to be displayed. Accordingly, discharges are selectively induced in the discharge cells in which the wall charges have been formed by the write discharges, causing the discharge cells to emit light. Hereinafter, a ratio of a display luminance of each sub-field to a reference display luminance is referred to as “a luminance weight”.

The plurality of scan electrodes are driven by a scan electrode driving circuit, the plurality of sustain electrodes are driven by a sustain electrode driving circuit, and the plurality of data electrodes are driven by a data electrode driving circuit.

The scan electrode driving circuit includes a plurality of scan ICs (Integrated Circuits) connected to the plurality of scan electrodes, respectively. Moreover, the scan electrode driving circuit has a first node to which a low potential is applied and a second node to which a high potential is applied. Each scan IC includes a first switch connected between the scan electrode and the first node and a second switch connected between the scan electrode and a second node. A capacitor that holds a constant voltage is connected between the first node and the second node. This causes a potential of the second node to be higher than a potential of the first node by the constant voltage.

The potential of the first node is controlled by a voltage application circuit, and either a first switch or a second switch of each scan IC is selectively turned on. Accordingly, driving voltages having predetermined waveforms are applied to the respective scan electrodes in the setup period, the write period and the sustain period (see Patent Documents 1 and 2, for example).

[Patent Document 1] JP 2004-287003 A

[Patent Document 2] JP 2005-266776 A

### DISCLOSURE OF THE INVENTION

### Problems to be Solved by the Invention

As described above, the potential of the second node is higher than the potential of the first node by the constant voltage in the scan electrode driving circuit. When the scan ICs are switched from a state where the second switches are turned on to a state where the first switches are turned on, the potential of the scan electrodes rapidly rises. In this case, a protective resistance is provided between the second node and the first switches of the scan ICs in order to restrict currents flowing from the second node to the scan ICs. This prevents large currents from flowing into the scan ICs.

However, temporary abnormal operation of the scan ICs may cause the first switches to be fixed in the ON state in a time period where the first switches are supposed to be turned off. In this case, an unexpected high voltage is applied to the scan electrodes.

For example, the first switches of the plurality of scan ICs are fixed in the OFF state and the second switches thereof are fixed in the ON state in the sustain period in normal operation. In this state, a pulse voltage is repeatedly applied to the first node. This causes sustain pulses to be applied to the scan electrodes.

When the first switches are fixed in the OFF state and the second switches are fixed in the ON state because of the temporary abnormal operation of the scan ICs in such a sustain period, the unexpected high voltage is repeatedly applied to the scan electrodes. As a result, the large current repeatedly flows to the protective resistance, so that the protective resistance may be heated or solder may be molten.

Meanwhile, in the setup period, the first and second switches of the scan ICs are selectively turned on or off, so that setup waveforms having a high voltage are applied to the scan electrodes.

Therefore, it is not easy to distinguish between the case where the high voltage is applied to the scan electrodes in the normal operation and the case where the high voltage is applied to the scan electrodes in the abnormal operation. This makes it difficult to detect the abnormal operation of the scan ICs.

An object of the present invention is to provide a driving device and a driving method of a plasma display panel capable of detecting an abnormal operation of switch circuits, and a plasma display device using the same.

### Means for Solving the Problems

(1) According to an aspect of the present invention, a driving device of a plasma display panel that drives the plasma display panel including a plurality of discharge cells at intersections of a plurality of scan electrodes and a plurality of sustain electrodes with a plurality of data electrodes includes a plurality of switch circuits that are provided corresponding to the plurality of scan electrodes and selectively connect either a first node or a second node to the plurality of scan electrodes, a voltage application circuit that changes a potential of the first node, a voltage hold circuit that holds a voltage between the first node and the second node to a first voltage, and a protection circuit that is provided between the voltage hold circuit and the second node, wherein the protection circuit includes a protective resistance connected between the voltage hold circuit and the second node, a rectification circuit that rectifies a voltage generated in the protective resistance, and a detection circuit that detects occurrence of an abnormal operation based on the voltage rectified by the rectification circuit.

In the driving device, the voltage between the first node and the second node is held at the first voltage by the voltage hold circuit. Thus, the potential of the second node is higher than the potential of the first node by the first voltage. In this state, the potential of the first node is changed by the voltage detection circuit, and either the first node or the second node is selectively connected to the plurality of scan electrodes by the plurality of switch circuits. This causes various driving waveforms to be applied to the plurality of scan electrodes.

The protective resistance is provided between the voltage hold circuit and the first node. In the normal operation, the switch circuits switch between the state in which the first node is connected to the scan electrodes and the state in which the second node is connected to the scan electrodes, so that a pulse voltage is generated in the protective resistance of the protection circuit. Also, the pulse voltage is generated in the protective resistance of the protection circuit by the abnormal operation of the switch circuits.

The pulse voltage generated in the protective resistance is rectified by the rectification circuit. A peak value and a rate of generation of the pulse voltage that is generated in the protective resistance in the abnormal operation of the switch circuits are different from a peak value and a rate of generation of the pulse voltage that is generated in the protective resistance by the operation of the switch circuits in the normal operation. Thus, the voltage rectified by the rectification circuit in the abnormal operation is different from the voltage rectified by the rectification circuit in the normal operation.

Accordingly, the occurrence of the abnormal operation can be detected by the detection circuit of the switch circuits based on the voltage rectified by the rectification circuit.

(2) The detection circuit may output a detection signal indicating the occurrence of the abnormal operation when the voltage rectified by the rectification circuit is higher than a first value.

In this case, the first value is set to a value between the voltage rectified by the rectification circuit in the abnormal operation and the voltage rectified by the rectification circuit in the normal operation, thereby allowing the detection signal indicating the occurrence of the abnormal operation to be output. A power supply circuit of the driving device can be temporarily stopped using the detection signal. Accordingly, the switch circuits can be restored to the normal operation when the switch circuits are subjected to the temporary abnormal operation.

(3) The rectification circuit may include a capacitive element, a first resistive element, a second resistive element and a unidirectional conductive element, and the capacitive element, the first resistive element and the unidirectional conductive element may be connected in series between the voltage hold circuit and the second node, the second resistive element may be connected in parallel to the capacitive element, and the unidirectional conductive element may allow a current to flow in one direction such that the capacitive element is charged by the voltage generated in the protective resistance.

In this case, the capacitive element is charged by the pulse voltage generated in the protective resistance through the first resistive element and the unidirectional conductive element, and the capacitive element is gradually discharged through the second resistive element after generation of the pulse voltage. This causes the pulse voltage generated in the protective resistance to be rectified.

As described above, the protection circuit having the simple configuration and the reduced number of components is provided, thus suppressing higher cost.

(4) The detection circuit may include a switching element that is turned on when the voltage rectified by the rectification circuit is higher than the first value and output the detection signal in response to the switching element that is turned on. In this case, the detection signal can be output with the simple configuration and the reduced number of components. This allows lower cost of the driving device.

(5) The driving device may drive the plasma display panel by a sub-field method where one field period includes a plurality of sub-fields, and each sub-field may include a write period for generating a write discharge by selectively applying a write pulse to the plurality of discharge cells and a sustain period for applying a sustain pulse to the plurality of discharge cells in order to cause the discharge cell in which the write discharge has been generated to emit light, the plurality of switch circuits may connect the first node to the plurality of scan electrodes in the sustain period, the voltage application circuit may apply the sustain pulse to the first node in the sustain period, and the detection circuit may detect an abnormal state in which the second node is connected to at least one of the plurality of scan electrodes in the sustain period based on whether the voltage rectified by the rectification circuit is not less than the first value.

In the sustain period, the sustain pulse is applied to the first node by the voltage application circuit. In this case, the pulse voltage that is higher than the sustain pulse by the first voltage is generated in the second node. In the normal operation, the first node is connected to the plurality of scan electrodes by the plurality of switch circuits in the sustain period. Meanwhile, when the second node is connected to the at least one of the plurality of scan electrodes by the plurality of switch circuits in the sustain period because of the abnormal operation of the switch circuits, the high pulse voltage is generated in the protective resistance. Since a rate of generation of the sustain pulse is high, the rate of generation of the pulse voltage in the protective resistance in the abnormal operation is also high. This causes the voltage rectified by the rectification circuit to be higher than the first voltage.

Accordingly, the abnormal state in which the second node is connected to the at least one of the plurality of scan electrodes in the sustain period can be detected based on whether the voltage rectified by the rectification circuit is not less than the first value.

(6) The switch circuits may switch at a predetermined timing a first state in which the first node is connected to the plurality of scan electrodes to a second state in which the second node is connected to the plurality of scan electrodes, and the first value may be set lower than the voltage rectified by the rectification circuit at the time of occurrence of the abnormal state in the sustain period and may be set higher than the voltage rectified by the rectification circuit at the time of switching of the first state to the second state.

In the normal operation, the switch circuits switch at the predetermined timing the first state in which the first node is connected to the plurality of scan electrodes to the second state in which the second node is connected to the plurality of scan electrodes. At this time, the pulse voltage is generated in the protective resistance.

As described above, when the first voltage is set lower than the voltage rectified by the rectification circuit at the time of occurrence of the abnormal state in the sustain period and is set higher than the voltage rectified by the rectification circuit at the time of switching from the first state to the second state, the occurrence of the abnormal state in the sustain period can be accurately detected without erroneously detecting the pulse voltage generated at the time of switching from the first state to the second state in the normal operation as the occurrence of the abnormal state.

(7) At least one sub-field of the plurality of sub-fields may include a setup period in which wall charges of the plurality of discharge cells are adjusted such that the write discharge can be performed, and the predetermined timing may be within the setup period.

In the setup period for adjusting the wall charges of the plurality of discharge cells such that the write discharges can be performed, the switching from the first state to the second state is performed. In this case, the occurrence of the abnormal state in the sustain period can be accurately detected without erroneously detecting the pulse voltage generated at the time of switching from the first state to the second state in the setup period in the normal operation as the occurrence of the abnormal state.

(8) The protection circuit may further include a voltage reduction circuit that applies to the rectification circuit a voltage that is lower than the voltage generated in the protective resistance by a second value.

In this case, when the voltage generated in the protective resistance is applied to the rectification circuit, the voltage is reduced by the second value. Therefore, the voltage rectified by the rectification circuit is reduced.

In a case where the pulse voltage generated in the normal operation has the higher peak value and the lower rate of generation than the pulse voltage generated in the abnormal operation, the voltage rectified by the rectification circuit is lowered. Accordingly, the occurrence of the abnormal state can be accurately detected without erroneously detecting the pulse voltage in the normal state having the higher peak value and the lower rate of generation as the occurrence of the abnormal state.

(9) The voltage reduction circuit may include a zener diode that is connected in series to the capacitive element, the first resistive element, the second resistive element and the unidirectional conductive element between the voltage hold circuit and the second node, and the zener diode may be connected opposite to the unidirectional conductive element and have a zener voltage that corresponds to the second value.

In this case, the occurrence of the abnormal state can be accurately detected without erroneously detecting the pulse voltage in the normal state having the higher peak value and the lower rate of generation as the occurrence of the abnormal state with the simple circuit configuration and the reduced number of components.

(10) The plurality of switch circuits may sequentially connect the first node to the plurality of scan electrodes each for a given period of time in the write period, and the second value may be set such that the voltage rectified by the rectification circuit is lower than the first value in the write period.

In this case, the occurrence of the abnormal state can be accurately detected without erroneously detecting the pulse voltage generated in the protective resistance in the write period as the occurrence of the abnormal state.

(11) The driving device may further include a voltage detection circuit that detects that the voltage held by the voltage hold circuit exceeds an allowable value, wherein the voltage detection circuit may output a common detection signal when the voltage held by the voltage hold circuit exceeds the allowable value or when the detection signal output from the protection circuit is received.

In this case, the common detection signal is output from the voltage hold circuit when the voltage held by the voltage hold circuit exceeds the allowable value or the detection signal output from the protection circuit is received. Components and the detection signal of the protection circuit and the voltage hold circuit are commonly used, so that the number of components and assembly steps are reduced. This allows lower cost of the driving device.

(12) According to another aspect of the present invention, a driving method of a plasma display panel including a plurality of discharge cells at intersections of a plurality of scan electrodes and a plurality of sustain electrodes with a plurality of data electrodes includes the steps of holding a voltage between a first node and a second node to a first voltage by a voltage hold circuit, changing a potential of the first node, selectively connecting either the first node or the second node to the plurality of scan electrodes, by a plurality of switch circuits that are provided corresponding to the plurality of scan electrodes, rectifying a voltage generated in a protective resistance connected between the voltage hold circuit and the second node, and detecting occurrence of an abnormal operation based on the rectified voltage.

In the driving method, the voltage between the first node and the second node is held at the first voltage by the voltage hold circuit. Thus, a potential of the second node is higher than the potential of the first node by the first voltage. In this state, the potential of the first node is changed, and either the first node or the second node is selectively connected to the plurality of scan electrodes by the plurality of switch circuits. This causes various driving waveforms to be applied to the plurality of scan electrodes.

The protective resistance is provided between the voltage hold circuit and the first node. In a normal operation, the switch circuits switch between the state in which the first node is connected to the scan electrodes and the state in which the second node is connected to the scan electrodes, so that a pulse voltage is generated in the protective resistance. Also, the pulse voltage is generated in the protective resistance by the abnormal operation of the switch circuits.

The pulse voltage generated in the protective resistance is rectified. A peak value and a rate of generation of the pulse voltage that is generated in the protective resistance in the abnormal operation of the switch circuits are different from a peak value and a rate of generation of the pulse voltage that is generated in the protective resistance by the operation of the switch circuits in the normal operation. Thus, the voltage rectified in the abnormal operation is different from the voltage rectified in the normal operation.

Accordingly, the occurrence of the abnormal operation of the switch circuits can be detected by the detection circuit based on the rectified voltage.

(13) According to still another aspect of the present invention, a plasma display device includes a plasma display panel including a plurality of discharge cells at intersections of a plurality of scan electrodes and a plurality of sustain electrodes with a plurality of data electrodes, and a driving device that drives the plurality of scan electrodes, wherein the driving device includes a plurality of switch circuits that are provided corresponding to the plurality of scan electrodes and selectively connect either a first node or a second node to the plurality of scan electrodes, a voltage application circuit that changes a potential of the first node, a voltage hold circuit that holds a voltage between the first node and the second node to a first voltage, and a protection circuit that is provided between the voltage hold circuit and the second node, the protection circuit includes a protective resistance connected between the voltage hold circuit and the second node, a rectification circuit that rectifies a voltage generated in the protective resistance, and a detection circuit that detects occurrence of an abnormal operation based on the voltage rectified by the rectification circuit.

In the plasma display device, the plurality of scan electrodes of the plasma display panel are driven by the driving device.

In the driving device, the voltage between the first node and the second node is held at the first voltage by the voltage hold circuit. Thus, a potential of the second node is higher than the potential of the first node by the first voltage. In this state, the potential of the first node is changed by the voltage detection circuit, and either the first node or the second node is selectively connected to the plurality of scan electrodes by the plurality of switch circuits. This causes various driving waveforms to be applied to the plurality of scan electrodes.

The protective resistance is provided between the voltage hold circuit and the first node. In a normal operation, the switch circuits switch between the state in which the first node is connected to the scan electrodes and the state in which the second node is connected to the scan electrodes, so that a pulse voltage is generated in the protective resistance of the protection circuit. Also, the pulse voltage is generated in the protective resistance of the protection circuit by the abnormal operation of the switch circuits.

The pulse voltage generated in the protective resistance is rectified by the rectification circuit. A peak value and a rate of generation of the pulse voltage that is generated in the protective resistance in the abnormal operation of the switch circuits are different from a peak value and a rate of generation of the pulse voltage that is generated in the protective resistance by the operation of the switch circuits in the normal operation. Thus, the voltage rectified by the rectification circuit in the abnormal operation is different from the voltage rectified by the rectification circuit in the normal operation.

Accordingly, the occurrence of the abnormal operation of the switch circuits can be detected by the detection circuit based on the voltage rectified by the rectification circuit.

### EFFECTS OF THE INVENTION

According to the present invention, the occurrence of the abnormal operation can be detected by the detection circuit of the switch circuits based on the voltage rectified by the rectification circuit.

### BRIEF DESCRIPTION OF THE DRAWINGS

FIG. 1 is an exploded perspective view showing part of a plasma display panel in a plasma display device according to an embodiment of the present invention.

FIG. 2 is a diagram showing an arrangement of electrodes of the panel in the embodiment of the present invention.

FIG. 3 is a block diagram of circuits of the plasma display device according to the embodiment of the present invention.

FIG. 4 is a waveform diagram of driving voltages in a sub-field configuration of the plasma display device of FIG. 3.

FIG. 5 is a circuit diagram showing the configuration of the scan electrode driving circuit.

FIG. 6 is a detailed timing chart in a setup period and a write period of a second sub-field of FIG. 4.

FIG. 7 is a detailed timing chart in a sustain period of the second sub-field of FIG. 4.

FIG. 8 is a schematic diagram for explaining a mechanism of generation of a normal pulse.

FIG. 9 is a waveform diagram showing one example of the normal pulse.

FIG. 10 is a schematic diagram for explaining a mechanism of generation of an address pulse.

FIG. 11 is a waveform diagram showing an example of the address pulse.

FIG. 12 is a schematic diagram for explaining a mechanism of generation of an abnormal pulse.

FIG. 13 is a waveform diagram showing an example of the abnormal pulse.

FIG. 14 (a) is a waveform diagram showing a voltage at both ends of a protective resistance in a normal operation and an abnormal operation, and FIG. 14 (b) is a waveform diagram showing the voltage of the scan electrode in the normal operation and the abnormal operation.

FIG. 15 is a circuit diagram showing the configuration of a protection circuit.

FIGS. 16 (a), (b), (c) are waveform diagrams showing the normal pulse, the address pulse and the abnormal pulse, respectively.

FIG. 17 is a block diagram showing the configurations of the protection circuit and a voltage abnormality detection circuit in which an abnormality detection signal is commonly used.

FIG. 18 is a circuit diagram showing the configuration of the voltage abnormality detection circuit.

### BEST MODE FOR CARRYING OUT THE INVENTION

The embodiments of the present invention will be described in detail referring to the drawings. The embodiments below describe a plasma display device.

### (1) Configuration of Panel

FIG. 1 is an exploded perspective view showing part of a plasma display panel in a plasma display device according to an embodiment of the present invention.

The plasma display panel (hereinafter abbreviated as the panel) 10 includes a front substrate 21 and a back substrate 31 that are made of glasses and arranged to be opposite to each other. A discharge space is formed between the front substrate 21 and the back substrate 31. A plurality of pairs of scan electrodes 22 and sustain electrodes 23 are formed in parallel with one another on the front substrate 21. Each pair of scan electrode 22 and sustain electrode 23 constitutes a display electrode. A dielectric layer 24 is formed so as to cover the scan electrodes 22 and the sustain electrodes 23, and a protective layer 25 is formed on the dielectric layer 24.

A plurality of data electrodes 32 covered with an insulator layer 33 are provided on the back substrate 31, and barrier ribs 34 are provided in a shape of a number sign on the insulator layer 33. Phosphor layers 35 are provided on a surface of the insulator layer 33 and side surfaces of the barrier ribs 34. Then, the front substrate 21 and the back substrate 31 are arranged to be opposite to each other such that the plurality of pairs of scan electrodes 22 and sustain electrodes 23 vertically intersect with the plurality of data electrodes 32, and the discharge space is formed between the front substrate 21 and the back substrate 31. The discharge space is filled with a mixed gas of neon and xenon, for example, as a discharge gas. Note that the configuration of the panel is not limited to the configuration described above. A configuration including the barrier ribs in a striped shape may be employed, for example.

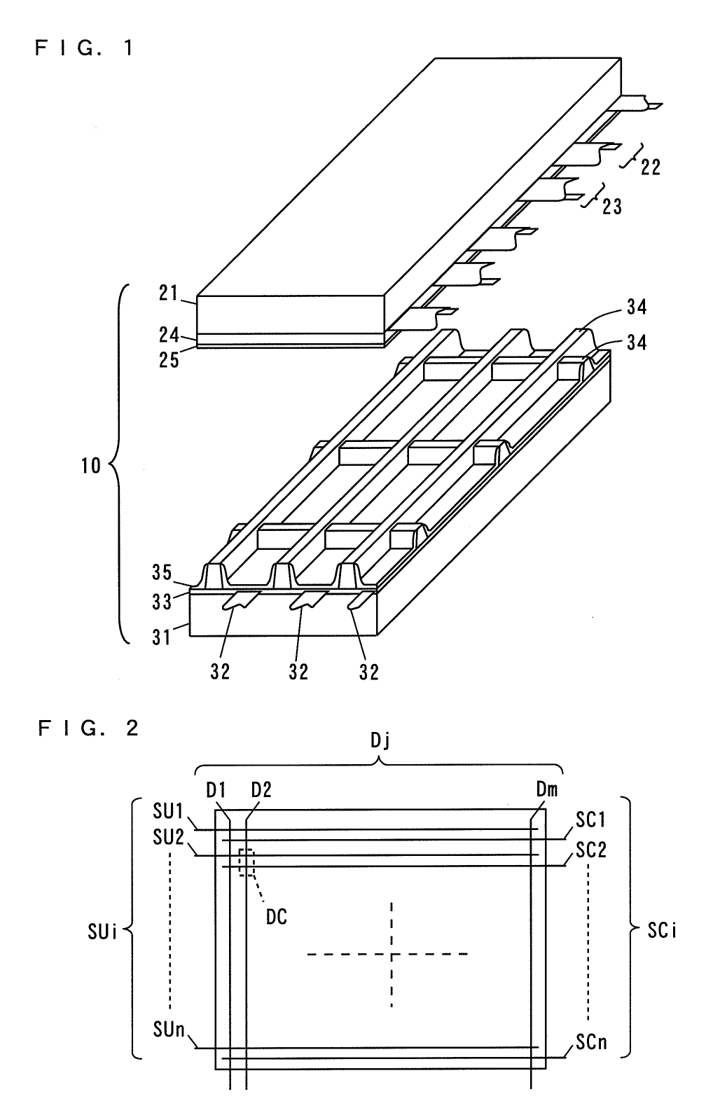

FIG. 2 is a diagram showing an arrangement of the electrodes of the panel in the embodiment of the present invention. N scan electrodes SC1 to SCn (the scan electrodes 22 of FIG. 1) and n sustain electrodes SU1 to SUn (the sustain electrodes 23 of FIG. 1) are arranged along a row direction, and m data electrodes D1 to Dm (the data electrodes 32 of FIG. 1) are arranged along a column direction. N and m are natural numbers of not less than two, respectively. A discharge cell DC is formed at an intersection of a pair of scan electrode SCi (i=1 to n) and sustain electrode SUi (i=1 to n) with one data electrodes Dj (j=1 to m). Accordingly, m×n discharge cells are formed in the discharge space.

### (2) Configuration of the Plasma Display Device

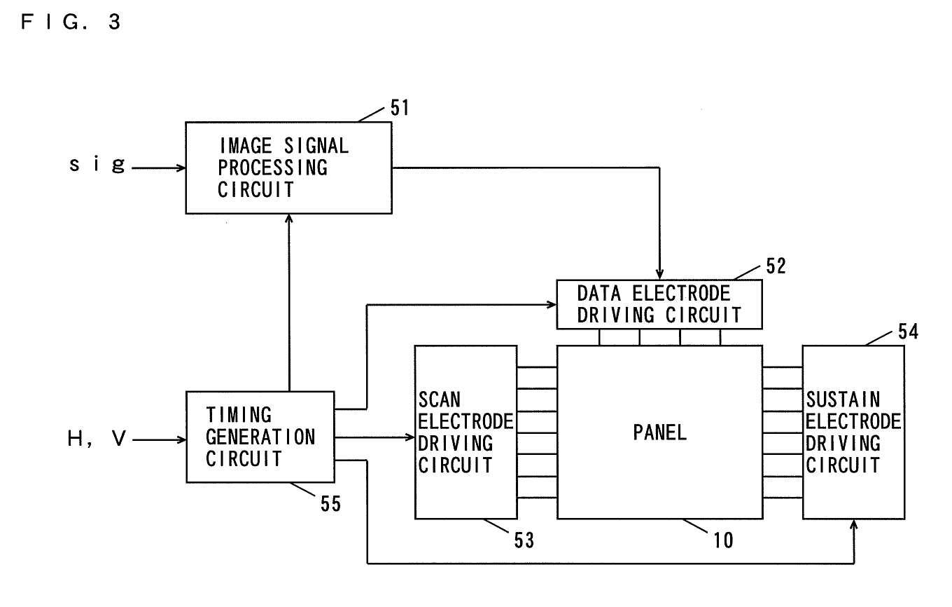

FIG. 3 is a circuit block diagram of the plasma display device according to the embodiment of the present invention.

This plasma display device includes the panel 10, an image signal processing circuit 51, a data electrode driving circuit 52, a scan electrode driving circuit 53, a sustain electrode driving circuit 54, a timing generation circuit 55 and a power supply circuit (not shown).

The image signal processing circuit 51 converts an image signal sig into image data corresponding to the number of pixels of the panel 10, divides the image data on each pixel into a plurality of bits corresponding to a plurality of sub-fields, and outputs them to the data electrode driving circuit 52.

The data electrode driving circuit 52 converts the image data for each sub-field into signals corresponding to the data electrodes D1 to Dm, respectively, and drives the data electrodes D1 to Dm based on the respective signals.

The timing generation circuit 55 generates timing signals based on a horizontal synchronization signal H and a vertical synchronization signal V, and supplies the timing signals to each of the driving circuit blocks (the image signal processing circuit 51, the data electrode driving circuit 52, the scan electrode driving circuit 53 and the sustain electrode driving circuit 54).

The scan electrode driving circuit 53 supplies driving waveforms to the scan electrodes SC1 to SCn based on the timing signals, and the sustain electrode driving circuit 54 supplies driving waveforms to the sustain electrodes SU1 to SUn based on the timing signals.

### (3) Sub-Field Configuration

Next, a sub-field configuration is explained. In a sub-field method, one field is divided into a plurality of sub-fields on a time base, and respective luminance weights are set for the plurality of sub-fields.

For example, one field is divided into ten sub-fields (hereinafter referred to as a first SF, a second SF, . . . and a tenth SF) on the time base, and the sub-fields have the luminance weights of 0.5, 1, 2, 3, 6, 9, 15, 22, 30 and 40, respectively.

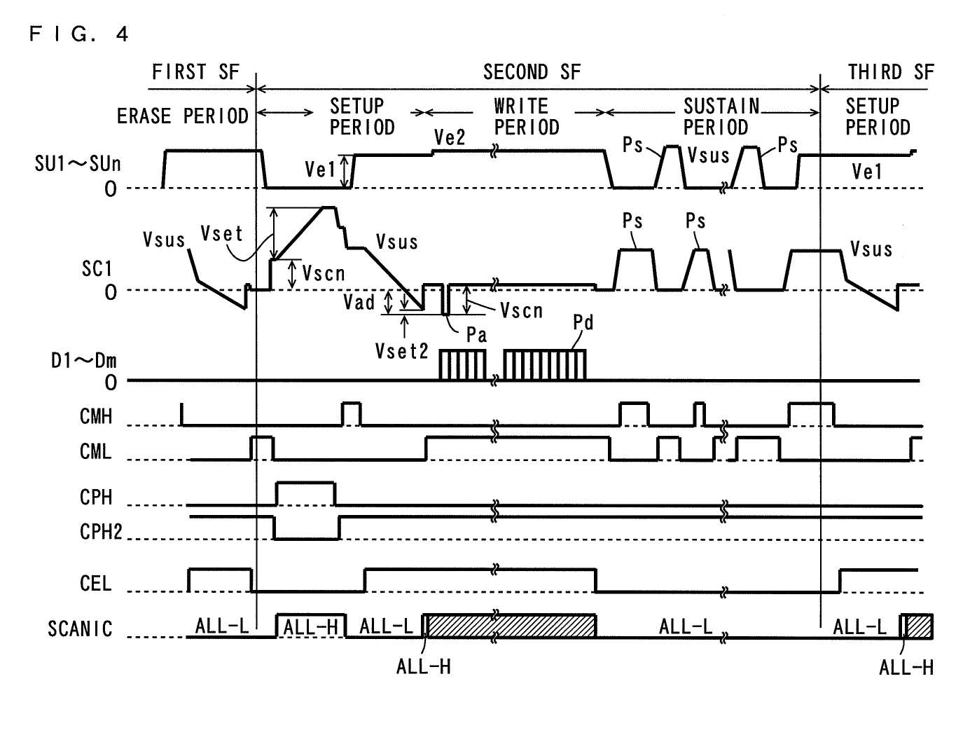

FIG. 4 is a driving voltage waveform diagram in the sub-field configuration of the plasma display device of FIG. 3.

The driving waveforms of the sustain electrodes SU1 to SUn, one scan electrode SC1 and the data electrodes D1 to Dm are shown in upper stages of FIG. 4. A period from an erase period of the first SF to a setup period of the third SF in one field is shown. Here, description is mainly made of the second SF.

In the first half of a setup period of the second SF, the data electrodes D1 to Dm and the sustain electrodes SU1 to SUn are held at 0 V (a ground potential), and a ramp voltage is applied to the scan electrodes SC1 to SCn. This ramp voltage gradually rises from a positive potential Vscn that is not more than a discharge start voltage toward a positive potential (Vscn+Vset) that exceeds the discharge start voltage. Then, first weak setup discharges are induced in all the discharge cells, so that negative wall charges are stored on the scan electrodes SC1 to SCn while positive wall charges are stored on the sustain electrodes SU1 to SUn and the data electrodes D1 to Dm, respectively. Here, a voltage caused by wall charges stored on the dielectric layer, the phosphor layer and so on covering the electrode is referred to as a wall voltage on the electrode.

In the subsequent second half of the setup period, the sustain electrodes SU1 to SUn are kept at a positive potential Ve1, and the ramp voltage that gradually falls from the positive potential (Vscn+Vset) toward a negative potential (−Vad) is applied to the scan electrodes SC1 to SCn. Then, second weak setup discharges are induced in all the discharge cells, so that the wall voltage on the scan electrodes SC1 to SCn and the wall voltage on the sustain electrodes SU1 to SUn are weakened, and the wall voltage on the data electrodes D1 to Dm are adjusted to a value suitable for a write operation.

In this manner, a setup operation for all the cells, in which the setup discharges are generated in all the discharge cells, is performed in the setup period of the second SF.

In a write period of the second SF, a potential Vet is applied to the sustain electrodes SU1 to SUn, and the scan electrodes SC1 to SCn are temporarily held at a potential (Vscn−Vad). Next, a positive write pulse Pd is applied to a data electrode Dk (k is any of 1 to m), among the data electrodes D1 to Dm, of the discharge cell that should emit light on a first row while a negative scan pulse voltage Pa (=−Vad) is applied to the scan electrode SC1 on the first row. Then, a voltage at an intersection of the data electrode Dk and the scan electrode SC1 attains a value obtained by adding the wall voltage on the data electrode Dk and the wall voltage on the scan electrode SC1 to an externally applied voltage (Pd—Pa), exceeding the discharge start voltage. This generates a write discharge between the data electrode Dk and the scan electrode SC1 and between the sustain electrode SU1 and the scan electrode SC1. As a result, in the discharge cell, the positive wall charges are stored on the scan electrode SC1, the negative wall charges are stored on the sustain electrode SU1 and the negative wall charges are stored on the data electrode Dk.

In this manner, the write operation for generating the write discharge in the discharge cell that should emit light on the first row to cause the wall charges to be stored on each of the electrodes is performed. On the other hand, since a voltage at an intersection of a data electrode Dh (h≠k) to which the write pulse Pd has not been applied and the scan electrode SC1 does not exceed the discharge start voltage, the write discharge is not generated. The above-described write operation is sequentially performed in the discharge cells on the first row to the n-th row, and the write period is then finished.

In a subsequent sustain period, the sustain electrodes SU1 to SUn are returned to 0 V, and a sustain pulse Ps (=Vsus) is applied to the scan electrodes SC1 to SCn for the first time in the sustain period. At this time, in the discharge cell in which the write discharge has been generated in the write period, a voltage between the scan electrode SCi and the sustain electrode SUi attains a value obtained by adding the wall voltage on the scan electrode SCi and the wall voltage on the sustain electrode SUi to the sustain pulse Ps (=Vsus), exceeding the discharge start voltage. This induces a sustain discharge between the scan electrode SCi and the sustain electrode SUi, causing the discharge cell to emit light. As a result, the negative wall charges are stored on the scan electrode SCi, the positive wall charges are stored on the sustain electrode SUi, and the positive wall charges are stored on the data electrode Dk.

In the discharge cell in which the write discharge has not been generated in the write period, the sustain discharge is not induced and the wall charges are held in a state at the end of the setup period. Next, the scan electrodes SC1 to SCn are returned to 0 V, and the sustain pulse Ps is applied to the sustain electrodes SU1 to SUn. Then, since the voltage between the sustain electrode SUi and the scan electrode SCi exceeds the discharge start voltage in the discharge cell in which the sustain discharge has been induced, the sustain discharge is again induced between the sustain electrode SUi and the scan electrode SCi, the negative wall charges are stored on the sustain electrode SUi, and the positive wall charges are stored on the scan electrode SCi.

Similarly to this, a predetermined number of sustain pulses Ps are alternately applied to the respective scan electrodes SC1 to SCn and sustain electrodes SU1 to SUn, so that the sustain discharges are continuously performed in the discharge cells in which the write discharges have been generated in the write period. In this manner, a sustain operation is finished in the sustain period.

In the setup period of the third SF, the sustain electrodes SU1 to SUn are held at the potential Ve1, the data electrodes D1 to Dm are held at 0 V, and the ramp voltage that gradually falls from the positive potential Vsus toward the negative potential (−Vad) is applied to the scan electrodes SC1 to SCn. Then, weak setup discharges are generated in the discharge cells in which the sustain discharges have been induced in the sustain period of the preceding sub-field. Accordingly, the wall voltage on the scan electrodes SCi and the wall voltage on the sustain electrodes SUi are weakened, and the wall voltage on the data electrode Dk is adjusted to the value suitable for the write operation.

Meanwhile, the discharges are not generated and the wall charges are kept constant in the state at the end of the setup period of the preceding sub-field in the discharge cells in which the write discharges and the sustain discharges have not been induced in the preceding sub-field.

As described above, a selective setup operation for selectively generating the setup discharges in the discharge cells in which the sustain discharges have been induced in the immediately preceding sub-field is performed in the setup period of the third SF.

### (4) Configuration of the Scan Electrode Driving Circuit 53

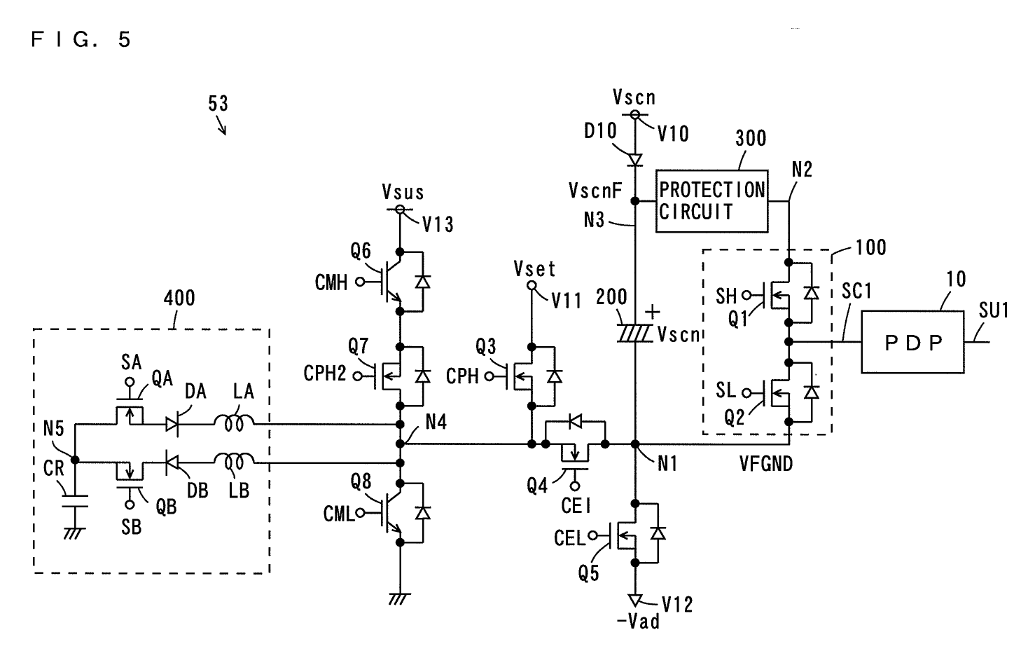

FIG. 5 is a circuit diagram showing the configuration of the scan electrode driving circuit 53.

The scan electrode driving circuit 53 includes a scan IC (Integrated Circuit) 100, a DC power supply 200, a protection circuit 300, a recovery circuit 400, a diode D10, n-channel field effect transistors (hereinafter abbreviated as transistors) Q3 to Q5, Q7 and NPN bipolar transistors (hereinafter abbreviated as transistors) Q6, Q8. The one scan IC 100 connected to the one scan electrode SC1 in the scan electrode driving circuit 53 is shown in FIG. 5. Scan ICs that are the same as the scan IC 100 of FIG. 5 are connected to the other scan electrodes SC2 to SCn, respectively.

The scan IC 100 includes n-channel field effect transistors (hereinafter abbreviated as transistors) Q1, Q2. The recovery circuit 400 includes n-channel field effect transistors (hereinafter abbreviated as transistors) QA, QB, recovery coils LA, LB, a recovery capacitor CR and diodes DA, DB.

The scan IC 100 is connected between a node N1 and a node N2. The transistor Q1 of the scan IC 100 is connected between the node N2 and the scan electrode SC1, and the transistor Q2 is connected between the scan electrode SC1 and the node N1. A control signal SH is applied to a gate of the transistor Q1, and a control signal SL is applied to a gate of the transistor Q2.

The protection circuit 300 is connected between the node N2 and a node N3. The protection circuit 300 includes a protective resistance. Details of the configuration and operation of the protection circuit 300 will be described later.

A power supply terminal V10 that receives the voltage Vscn is connected to the node N3 through the diode D10. The DC power supply 200 is connected between the node N1 and the node N3. The DC power supply 200 is composed of an electrolytic capacitor, and functions as a floating power supply that holds the voltage Vscn. Hereinafter, the potential of the node N1 is referred to as VFGND, and the potential of the node N3 is referred to as VscnF. The potential VscnF of the node N3 has a value obtained by adding the potential Vscn to the potential VFGND of the node N1. That is, VscnF=VFGND+Vscn.

The transistor Q3 is connected between a power supply terminal V11 that receives the voltage Vset and a node N4, and a control signal CPH is applied to its gate. A transistor Q4 is connected between the node N1 and the node N4, and a control signal CEI is applied to its gate. The transistor Q5 is connected between the node N1 and a power supply terminal V12 that receives the negative voltage (−Vad), and a control signal CEL is applied to its gate. The control signal CEI is an inverted signal of the control signal CEL.

The transistors Q6, Q7 are connected between a power supply terminal V13 that receives the voltage Vsus and the node N4. A control signal CMH is applied to a base of the transistor Q6, and a control signal CPH2 is applied to a gate of the transistor Q7. The transistor Q8 is connected between the node N4 and a ground terminal, and a control signal CML is applied to its base.

Between the node N4 and a node N5, the recovery coil LA, the diode DA and the transistor QA are connected in series, and the recovery coil LB, the diode DB and the transistor QB are connected in series. The recovery capacitor CR is connected between the node N5 and the ground terminal.

### (5) Operation of the Scan Electrode Driving Circuit 53

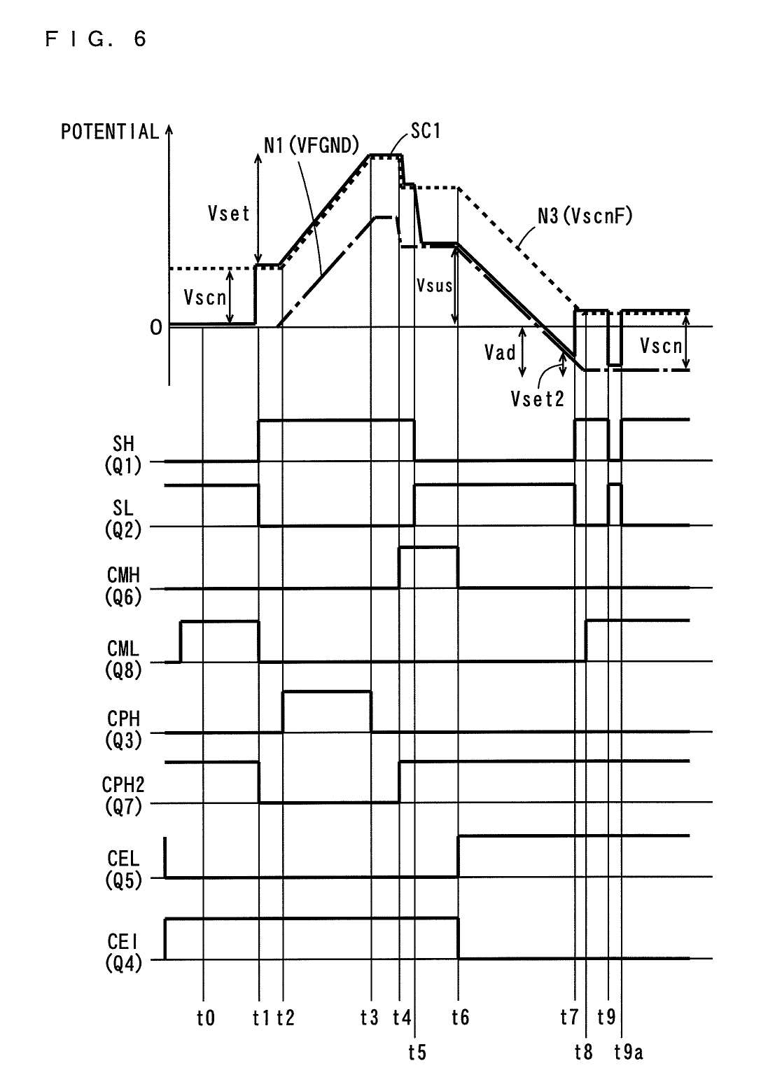

FIG. 6 is a detailed timing chart in the setup period and the write period of the second sub-field of FIG. 4.

Changes of the potential VFGND of the node N1 is indicated by the one-dot and dash line, changes of the potential VscnF of the node N3 is indicated by the dotted line, and changes of the potential of the scan electrode SC1 is indicated by the solid line in the top stage of FIG. 6. Note that control signals SA, SB applied to the recovery circuit 400 are not shown in FIG. 6.

At a starting time point t0 of the setup period, the control signals SH, CMH, CPH, CEL are at low levels, and the control signals SL, CML, CPH2, CEI are at high levels. This causes the transistors Q1, Q6, Q3, Q5 to be turned off and the transistors Q2, Q8, Q7, Q4 to be turned on. Thus, the node N1 attains the ground potential (0 V) and the potential VscnF of the node N3 attains Vscn. Since the transistor Q2 is turned on, the potential of the scan electrode SC1 attains the ground potential.

The control signals CML, CPH2 attain low levels and the transistors Q8, Q7 are turned off at a time point t1. Moreover, the control signal SH attains a high level and the control signal SL attains a low level. This causes the transistor Q1 to be turned on and the transistor Q2 to be turned off. Accordingly, the potential of the scan electrode SC1 rises to Vscn.

The control signal CPH attains a high level and the transistor Q3 is turned on at a time point t2. This causes the potential VFGND of the node N1 to gradually rise from the ground potential to Vset. In addition, the potential VscnF of the node N3 and the potential of the scan electrode SC1 rise from Vscn to (Vscn+Vset).

The control signal CPH attains a low level and the transistor Q3 is turned off at a time point t3. This causes the potential VHGND of the node N1 to be kept at Vset. Moreover, the potential VscnF of the node N3 and the potential of the scan electrode SC1 are kept at (Vscn+Vset).

The control signals CMH, CPH2 attain high levels and the transistors Q6, Q7 are turned on at a time point t4. This causes the potential VFGND of the node N1 to fall to Vsus. In addition, the potential VscnF of the node N3 and the potential of the scan electrode SC1 fall to (Vscn+Vsus).

The control signal SH attains a low level and the control signal SL attains a high level at a time point t5. This causes the transistor Q1 to be turned off and the transistor Q2 to be turned on. Thus, the potential of the scan electrode SC1 fall to Vsus.

The control signals CMH, CEI attain low levels and the transistors Q6, Q4 are turned off at a time point t6. Moreover, the control signal CEL attains a high level, and the transistor Q5 is turned on. This causes the potential VFGND of the node N1 and the potential of the scan electrode SC1 to gradually fall toward (−Vad). In addition, the potential VscnF of the node N3 gradually falls toward (−Vad+Vscn).

The control signal SH attains a high level and the control signal SL attains a low level at a time point t7. This causes the transistor Q1 to be turned on and the transistor Q2 to be turned off. Accordingly, the potential of the scan electrode SC1 rises from (−Vad+Vset2) to (−Vad+Vscn). Here, Vset2<Vscn.

The control signal CML attains a high level and the transistor Q8 is turned on at a time point t8 in the write period. This causes the node N4 to attain the ground potential. Here, since the transistor Q4 is turned off, the node N1 and the potential of the scan electrode SC1 are sustained at (−Vad+Vscn).

The control signal SH attains a low level and the control signal SL attains a high level at a time point t9. This causes the transistor Q1 to be turned off and the transistor Q2 to be turned on. Accordingly, the potential of the scan electrode SC1 falls from (−Vad+Vscn) to −Vad.

The control signal SH attains a high level and the control signal SL attains a low level at a time point t9a. This causes the transistor Q1 to be turned off and the transistor Q2 to be turned on. Thus, the potential of the scan electrode SC1 rises from −Vad to (−Vad+Vscn). As a result, the scan pulse is generated in the scan electrode SC1.

In this manner, the transistors Q1, Q2 of the scan IC 100 are turned on and off to cause the potential of the scan electrode SC1 to switch to the potential VFGND of the node N1 and the potential VscnF of the node N3.

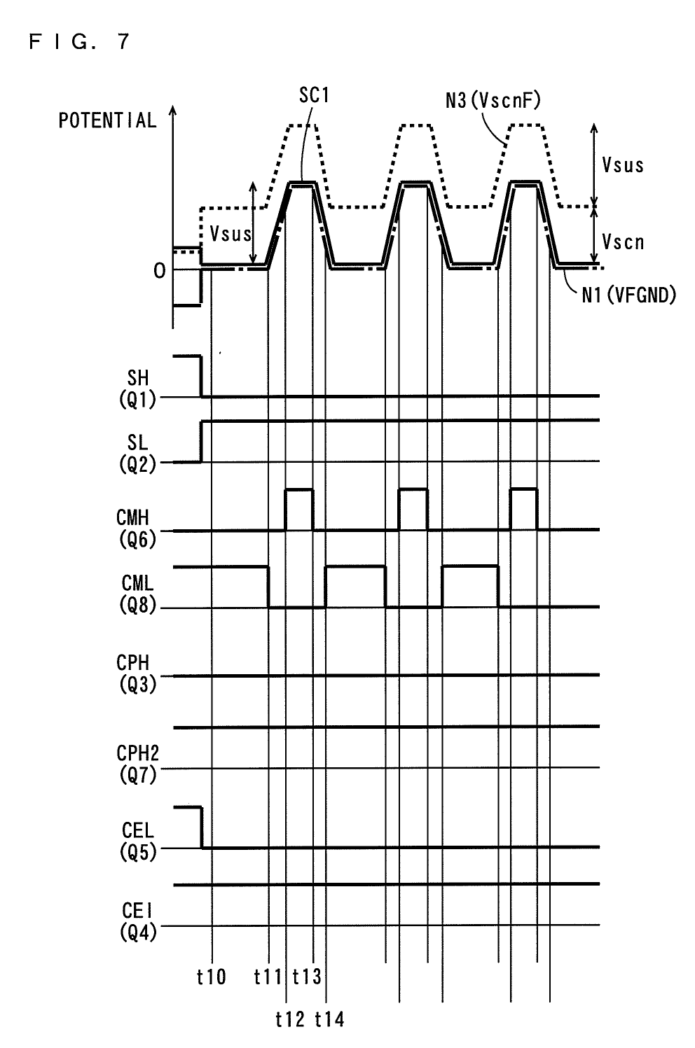

FIG. 7 is a detailed timing chart in the sustain period of the second sub-field of FIG. 4.

Changes of the potential VFGND of the node N1 is indicated by the one-dot and dash line, changes of the potential VscnF of the node N3 is indicated by the dotted line, and changes of the potential of the scan electrode SC1 is indicated by the solid line in the top stage of FIG. 7. Note that the control signals SA, SB applied to the recovery circuit 400 are not shown in FIG. 7.

The control signals SH, CMH, CPH, CEL are at low levels and the control signals SL, CML, CPH2 and CEI are at high levels at a starting time point t10 of the sustain period. This causes the transistors Q1, Q6, Q3, Q5 to be turned off and the transistors Q2, Q8, Q7, Q4 to be turned on. Thus, the node N1 attains the ground potential, and the potential VscnF of the node N3 attains Vscn. Since the transistor Q2 is turned on, the potential of the scan electrode SC1 is at the ground potential.

The control signal CML attains a low level and the transistor Q8 is turned off at a time point t11. At this time, the control signal SA (see FIG. 5) attains a high level and the transistor QA is turned on. This causes a current to be supplied from the recovery capacitor CR to the node N1 and the scan electrode SC1, causing the potential VFGND of the node N1 and the potential of the scan electrode SC1 to rise.

The control signal CMH attains a high level and the transistor Q6 is turned on at a time point t12. At this time, the control signal SA (see FIG. 5) attains a low level and the transistor QA is turned off. This causes the potential VFGND of the node N1 and the potential of the scan electrode SC1 to attain Vsus. In addition, the potential VscnF of the node N3 attains (Vscn+Vsus).

The control signal CMH attains a low level and the transistor Q6 is turned off at a time point t13. At this time, the control signal SB (see FIG. 5) attains a high level and the transistor QB is turned on. Thus, the current is supplied from the node N1 and the scan electrode SC1 to the recovery capacitor CR to cause the potential VFGND of the node N1 and the potential of the scan electrode SC1 to fall.

The control signal CML attains a high level and the transistor Q8 is turned on at a time point t14. At this time, the control signal SB (see FIG. 5) attains a low level and the transistor QB is turned off. This causes the potential VFGND of the node N1 and the potential of the scan electrode SC1 to attain the ground potential. In addition, the potential VscnF of the node N3 falls to Vscn.

In this manner, the potential VFGND of the node N1 and the potential of the scan electrode SC1 alternately change between the ground potential and Vsus. In addition, the potential VscnF of the node N3 alternately change between Vscn and (Vscn+Vsus).

Note that lower stages of FIG. 4 show waveforms of the control signals CMH, CML, CPH, CPH2, CEL and a state of the scan ICs 100 from the erase period of the first SF to the setup period of the third SF. “ALL-L” indicates that the transistors Q1 are turned off and the transistors Q2 are turned on in all the scan ICs 100, and “ALL-H” indicates that the transistors Q1 are turned on and the transistors Q2 are turned off in all the scan ICs 100.

### (6) Pulse Voltage Generated in the Protective Resistance of the Protection Circuit 300

Next, description is made of pulse voltages generated at both ends of the protective resistance of the protection circuit 300 of FIG. 5.

The pulse voltages generated at the both ends of the protective resistance of the protection circuit 300 include three types: a normal pulse, an address pulse and an abnormal pulse, described later. In the present embodiment, the protection circuit 300 detects the abnormal pulse out of the pulse voltages of three types, and generates an abnormality detection signal.

### (6-1) Normal Pulse

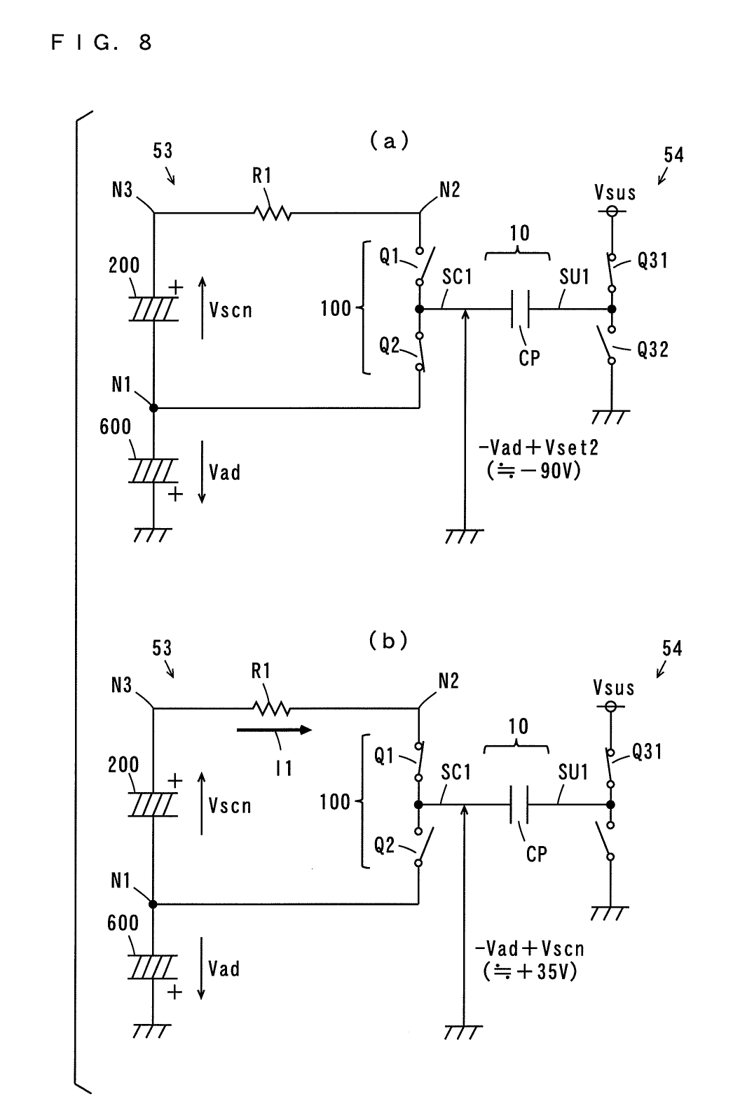

First, the normal pulse is described. FIG. 8 is a schematic diagram for explaining a mechanism of generation of the normal pulse. FIG. 8 shows the scan electrode driving circuit 53, a panel capacitance CP and part of the sustain electrode driving circuit 54 in a simplified manner.

FIG. 8 shows the DC power supply 200 that holds the voltage Vscn, the protective resistance R1 included in the protection circuit 300, the transistors Q1, Q2 included in the scan IC 100, and a DC power supply 600 that generates the negative voltage (−Vad). FIG. 8 also shows the one scan electrode SC1 connected to one end of total capacitance (hereinafter referred to as panel capacitance) CP of the panel 10, the one sustain electrode SU1 connected to the other end of the panel capacitance CP, and transistors Q31, Q32 included in the sustain electrode driving circuit 54.

As shown in FIG. 8 (a), the transistors Q1 are turned off and the transistors Q2 are turned on in all the scan ICs 100 immediately before the time point t7 of FIG. 6. In addition, the negative potential (−Vad) is applied to the node N1. In this case, the potential of the scan electrode SC1 is (−Vad+Vset2). In addition, the transistor Q31 of the sustain electrode driving circuit 54 is turned on, and the transistor Q 32 thereof is turned off. The potential (−Vad+Vset2) is about −90 V, for example.

As shown in FIG. 8 (b), the transistors Q1 are turned on and the transistors Q2 are turned off in all the scan ICs 100 immediately after the time point t7 of FIG. 6. This causes the potential of the scan electrode SC1 to attain (−Vad+Vscn). The potential (−Vad+Vscn) is about +35 V, for example.

In this case, a current I1 flows through the protective resistance R1, and the panel capacitance CP is charged. This charge current generates the pulse voltage at the both ends of the protective resistance R1. As described above, this pulse voltage is referred to as the normal pulse.

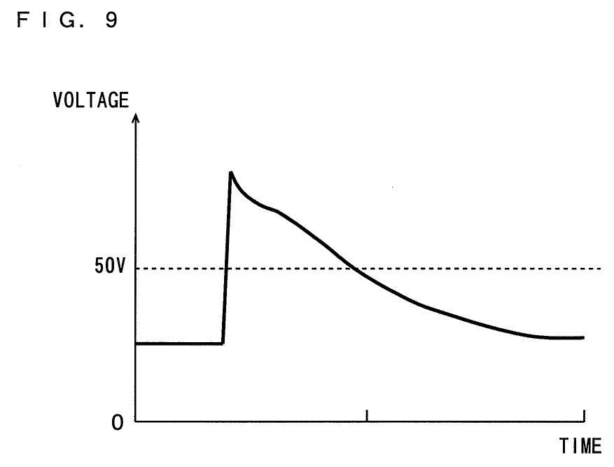

FIG. 9 is a waveform diagram showing one example of the normal pulse. In the example of FIG. 9, the peak of the normal pulse exceeds 50 V. Such a normal pulse is generated about 10 to 20 times per one field (16.6 ms).

### (6-2) The Address Pulse

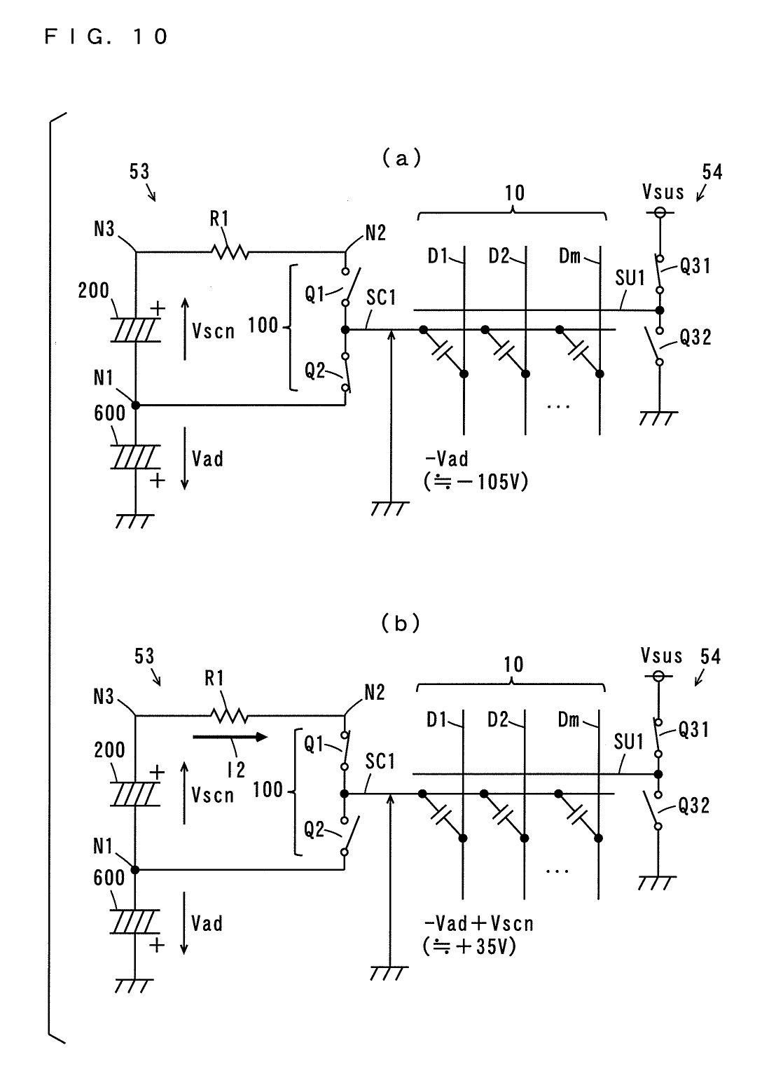

Next, the address pulse is described. FIG. 10 is a schematic diagram for explaining a mechanism of generation of the address pulse. FIG. 10 shows the scan electrode driving circuit 53, the panel 10 and part of the sustain electrode driving circuit 54 in a simplified manner.

When a horizontally striped image is displayed on a screen of the panel 10 during the normal operation, the transistors Q1 of n scan ICs 100 connected to n scan electrodes SC1 to SCn are sequentially turned on, and the potentials of m data electrodes D1 to Dm of the panel 10 are simultaneously switched between a high level and a low level in a repetitive manner.

In this case, the capacitances of the discharge cells formed between the scan electrode SCi and m data electrodes D1 to Dm are simultaneously charged.

As shown in FIG. 10 (a), for example, the transistor Q1 is turned off and the transistor Q2 is turned on in the scan IC 100 connected to the scan electrode SC1 immediately before the time point t9a of FIG. 6. In addition, the negative potential (−Vad) is applied to the node N1. In this case, the potential of the scan electrode SC1 is −Vad. Moreover, the transistor Q31 of the sustain electrode driving circuit 54 is turned on, and the transistor Q32 thereof is turned off. The potential (−Vad) is about −105V, for example.

As shown in FIG. 10 (b), the transistor Q1 is turned on and the transistor Q2 is turned off in the scan IC 100 connected to the scan electrode SC1 immediately after the time point t9a of FIG. 6. Thus, the potential of the scan electrode SC1 is (−Vad+Vscn). The potential (−Vad+Vscn) is about +35 V, for example.

In this case, a current I2 flows through the protective resistance R1, and the capacitances of the discharge cells formed between the scan electrode SC1 and the data electrodes D1 to Dm are simultaneously charged. The charge current generates the pulse voltage at the both ends of the protective resistance R1. As described above, the pulse voltage is referred to as the address pulse.

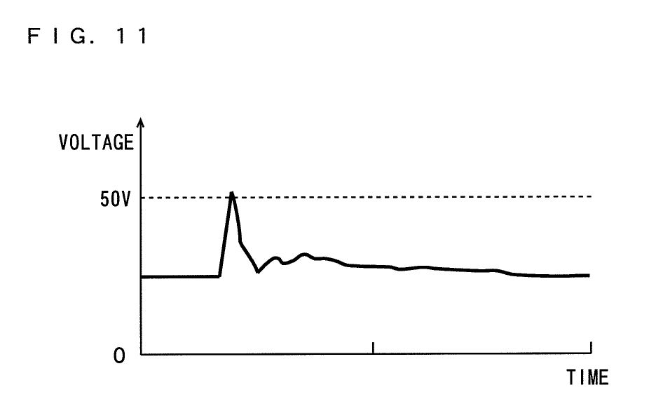

FIG. 11 is a waveform diagram showing one example of the address pulse. In the example of FIG. 11, the peak of the address pulse is about 50 V. Such an address pulse is generated not only in a horizontally striped image alternately having one white line and one black line, but also in the case of displaying images with various patterns such as a horizontally striped image having a white line on every third line, a horizontally striped image having a white line on every fourth line, or a horizontally striped image alternately having two white lines and two black lines. For example, when the panel 10 has 768 lines and ten sub-fields, the address pulse is generated about 4000 times per one field (16.6 ms). Note that when an upper half region and a lower half region of the panel 10 are separately driven by respective scan electrode driving circuits, sustain electrode driving circuits and data electrode driving circuits, the address pulse is generated about 2000 times per one field (16.6 ms).

### (6-3) Abnormal Pulse

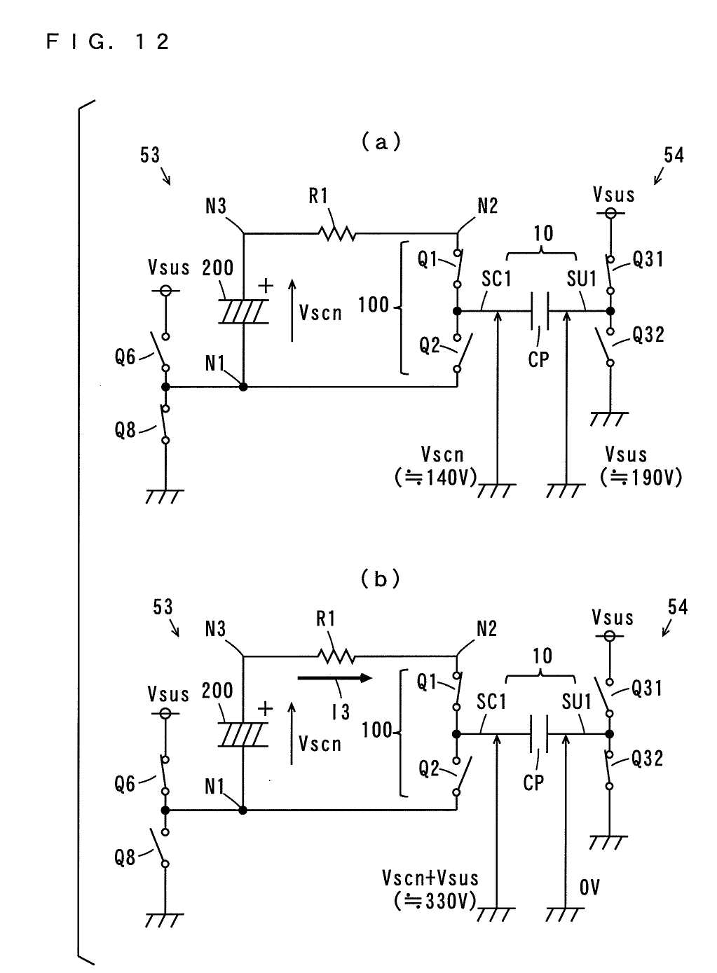

Then, the abnormal pulse is described. FIG. 12 is a schematic diagram for explaining a mechanism of generation of the abnormal pulse. FIG. 12 shows the scan electrode driving circuit 53, the panel capacitance CP and part of the sustain electrode driving circuit 54 in a simplified manner.

As shown in FIG. 7, the transistors Q1 are turned off and the transistors Q2 are turned on in all the scan ICs 100 in the sustain period during the normal operation. In the abnormal operation, however, the transistors Q1 are turned on and the transistors Q2 are turned off in all the scan ICs 100 regardless of the pattern of the images displayed on the panel 10. Accordingly, discharge currents between the scan electrodes SC1 to SCn and the sustain electrodes SU1 to SUn flow through the protective resistance R1 in the sustain period during the abnormal operation.

As shown in FIG. 12 (a), when the transistor Q6 of the scan electrode driving circuit 53 is turned off and the transistor Q8 thereof is turned on, the transistor Q31 of the sustain electrode driving circuit 54 is turned on and the transistor Q32 thereof is turned off. When the transistor Q1 of the scan IC 100 is turned on and the transistor Q2 thereof is turned off because of the abnormal operation, the potential of the scan electrode SC1 is Vscn. The potential Vscn is about 140 V, for example. In addition, the potential of the sustain electrode SU1 is Vsus. The potential Vsus is about 190 V, for example. In this case, since a potential difference between the scan electrode SC1 and the sustain electrode SU1 does not exceed the discharge start voltage, a discharge is not generated in the discharge cell connected between the scan electrode SC1 and the sustain electrode SU1. This does not cause the discharge current to flow through the protective resistance R1.

As shown in FIG. 12 (b), when the transistor Q6 of the scan electrode driving circuit 53 is turned on and the transistor Q8 thereof is turned off, the transistor Q31 of the sustain electrode driving circuit 54 is turned off and the transistor Q32 thereof is turned on. When the transistor Q1 of the scan IC 100 is turned on and the transistor Q2 thereof is turned off because of the abnormal operation, the potential of the scan electrode SC1 is (Vscn+Vsus). The potential (Vscn+Vsus) is about 330 V, for example. Moreover, the potential of the sustain electrode SU1 is 0 V. In this case, since a potential difference between the scan electrode SC1 and the sustain electrode SU1 exceeds the discharge start voltage, a discharge is generated in the discharge cell connected between the scan electrode SC1 and the sustain electrode SU1. This causes a discharge current I3 to flow through the protective resistance R1.

In this manner, the potential of the sustain electrode SU1 alternately changes between Vsus and 0 V. In contrast, the potential of the scan electrode SC1 changes between Vscn and (Vscn+Vsus). Accordingly, the discharge current I3 flows only in one direction through the protective resistance R1. The discharge current I3 generates the pulse voltage at the both ends of the protective resistance R1. As described above, this pulse voltage is referred to as the abnormal pulse.

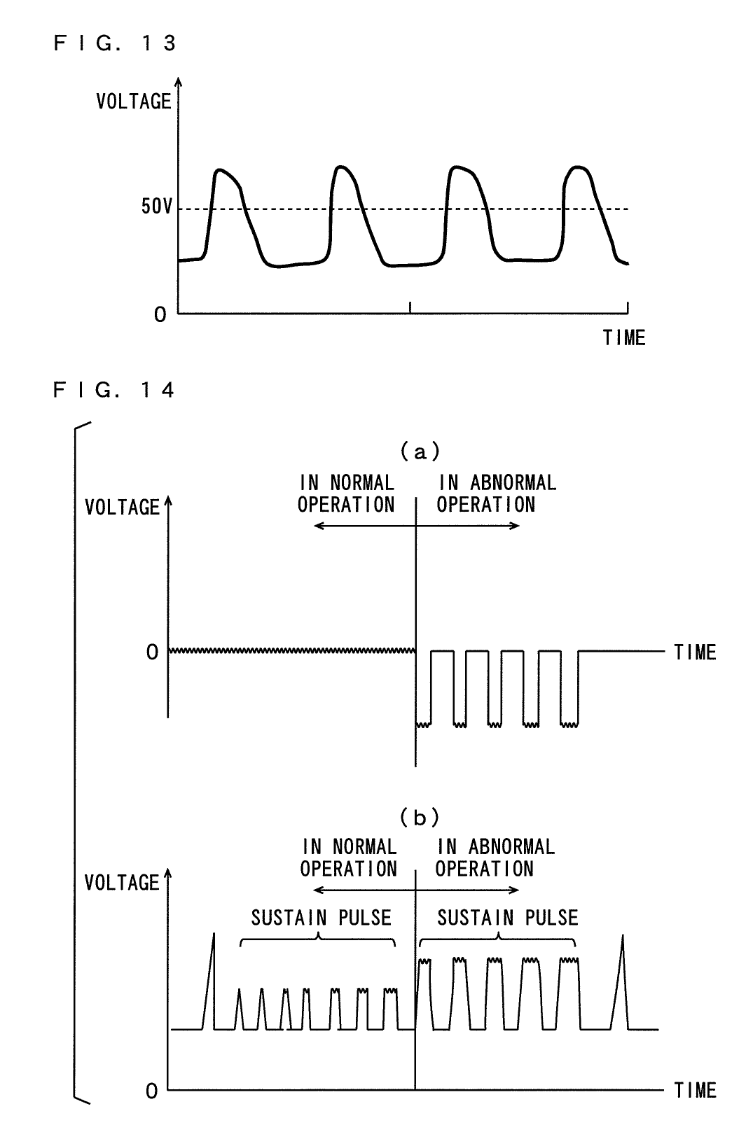

FIG. 13 is a waveform diagram showing one example of the abnormal pulse. In the example of FIG. 13, the peak of the abnormal pulse exceeds 50 V. Such an abnormal pulse is generated about 50 to 100 times per one field (16.6 ms).

### (6-4) Heating of the Protective Resistance R1 by the Abnormal Pulse

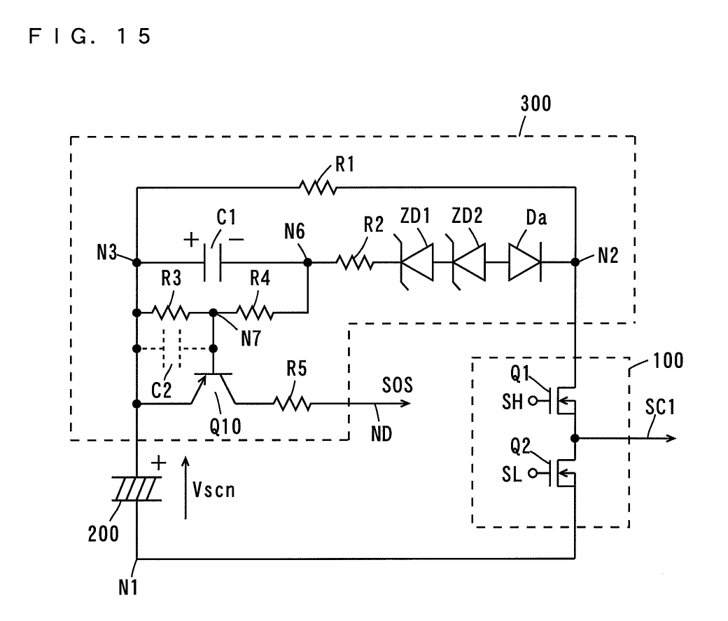

FIG. 14 (a) is a waveform diagram showing voltages at the both ends of the protective resistance R1 in the normal operation and the abnormal operation, and FIG. 14 (b) is a waveform diagram showing the voltage of the scan electrode SC1 in the normal operation and the abnormal operation.

In the normal operation, the current does not flow through the protective resistance R1 in the sustain period. Accordingly, a voltage amplitude at the both ends of the protective resistance R1 is substantially 0 V, as shown in FIG. 14 (a).

Meanwhile, as described above, when the transistors Q1, Q2 of the scan IC 100 are fixed in the ON state and OFF state, respectively, because of the abnormal operation, the discharge Current flows in one direction through the protective resistance R1 in the sustain period. Thus, the voltage amplitude at the both ends of the protective resistance R1 significantly increases as shown in FIG. 14 (a). Moreover, the sustain pulse applied to the scan electrode SC1 rises by the voltage Vscn in the sustain period as shown in FIG. 14 (b).

The discharge current flows through the protective resistance R1 because of such an abnormal operation, so that the protective resistance R1 is heated. This may cause the protective resistance to glow and solder to be molten.

In the present embodiment, the abnormal pulse is detected out of the normal pulse, the address pulse and the abnormal pulse by the protection circuit 300, and the abnormality detection signal is output.

The power supply circuit is temporarily stopped based on the abnormality detection signal.

### (7) Configuration and Operation of the Protection Circuit 300

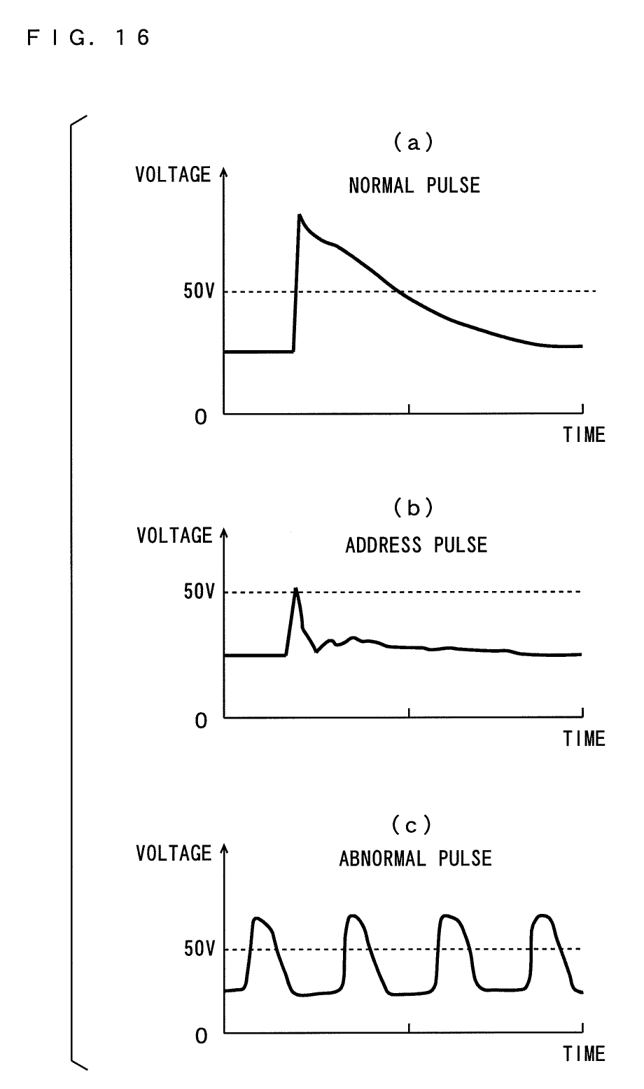

FIG. 15 is a circuit diagram showing the configuration of the protection circuit 300. While the protection circuit 300 provided corresponding to the scan electrode SC1 is shown in FIG. 15, the protection circuits 300 provided corresponding to the other scan electrodes SC2 to SCn have the same configuration as that shown in FIG. 15.

As shown in FIG. 15, the protection circuit 300 includes the protective resistance R1, the capacitor C1, a charge restriction resistance R2, zener diodes ZD1, ZD2, a rectifier diode Da, discharge resistances R3, R4, a PNP bipolar transistor (hereinafter abbreviated as a transistor) Q10 and a resistance R5. A value of the charge restriction resistance R2 is sufficiently smaller than a total value of the discharge resistances R3, R4.

The protective resistance R1 is connected between the node N3 and the node N2. The capacitor C1 is connected between the node 3 and a node N6. The charge restriction resistance R2, the zener diodes ZD1, ZD2 and the rectifier diode Da are connected in series between the node N6 and the node N2. The capacitor C1, the charge restriction resistance R2 and the rectifier diode Da constitute a rectification circuit. The zener diodes ZD1, ZD2 are connected opposite to the diode Da.

The discharge resistance R3 is connected between the node N3 and a node N7, and the discharge resistance R4 is connected between the node N7 and the node N6. A base of the transistor Q10 is connected to the node N7, an emitter thereof is connected to the node N3, and a collector thereof is connected to a node ND through the resistance R5.

When the pulse voltage is generated in the node N3, a current flows to the capacitor C1, the charge restriction resistance R2, the zener diodes ZD1, ZD2 and the diode Da. In this case, the current is rectified with a time constant determined by a value of the capacitor C1 and the value of the charge restriction resistance R2, and the capacitor C1 is charged. This causes the potential of the node N3 to rise. After generation of the pulse voltage, the capacitor C1 is gradually discharged through the discharge resistances R3, R4. This causes the potential of the node N3 to fall.

The above-described operation is repeated for each generation of the pulse voltage, so that the pulse voltage generated at the both ends of the protective resistance R1 is rectified. In this case, charge voltage of the capacitor C1 differs depending on a peak value and a rate of generation of the pulse voltage. That is, the potential of the node N7 differs depending on the peak value and the rate of generation of the pulse voltage. Here, the rate of generation of the pulse voltage is the number of generation of the pulse voltage in a given period of time (one field, for example).

When the potential of the node N7 exceeds a predetermined value, the transistor Q10 is turned on. This causes an abnormality detection signal SOS of high level to be output from the node ND.

Note that a capacitor C2 may be connected between the node N3 and the node N7 as indicated by the dotted line in order to remove a noise superimposed on the potential of the node N7.

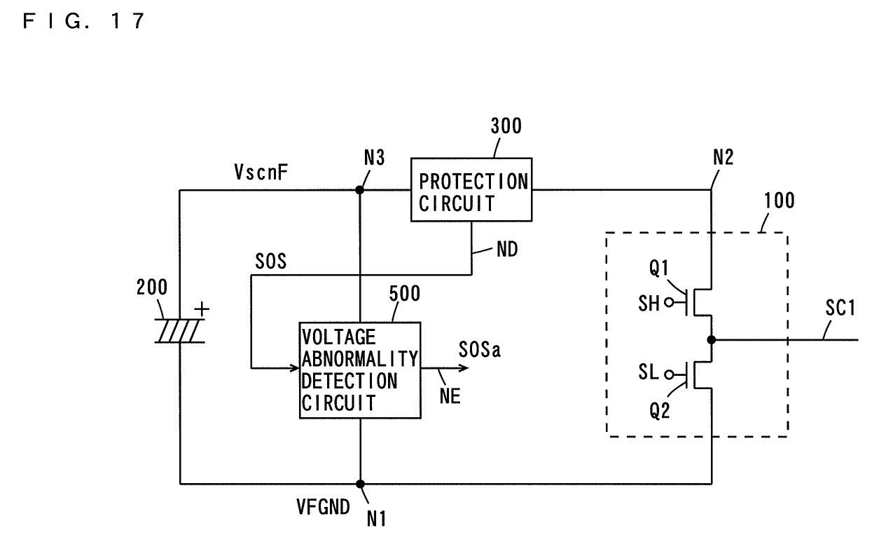

FIGS. 16 (a), (b), (c) are waveform diagrams showing the normal pulse, the address pulse and the abnormal pulse, respectively.

As shown in FIG. 16 (a) and FIG. 16 (c), the peak value of the normal pulse is higher than that of the abnormal pulse. Meanwhile, the normal pulse is generated about 10 to 20 times per one field (16.6 ms). In contrast, the abnormal pulse is generated about 50 to 1000 times per one field (16.6 ms).

Accordingly, the voltage rectified by the rectification circuit when the abnormal pulse is generated is higher than the voltage rectified by the rectification circuit when the normal pulse is generated. Therefore, the value of the capacitor C1, the value of the charge restriction resistance R2 and the values of the discharge resistances R3, R4 are set such that the transistor Q10 is turned on at the potential of the node N7 when the abnormal pulse is generated and the transistor Q10 is not turned on at the potential of the node N7 when the normal pulse is generated. Accordingly, generation of the abnormal pulse causes the abnormality detection signal SOS to be output, and generation of the normal pulse does not cause the abnormality detection signal SOS to be output.

In addition, the address pulse is generated about 2000 to 4000 times per one field (16.6 ms). Thus, a rate of generation of the address pulse is higher than that of the abnormal pulse. Meanwhile, a peak value of the address pulse is lower than that of the abnormal pulse as shown in FIG. 16 (b) and FIG. 16 (c).

Therefore, zener voltages of the zener diodes ZD1, ZD2 are set higher than the peak value of the address pulse in the protection circuit 300 of the present embodiment. Accordingly, the current does not flow through the rectification circuit constituted by the capacitor C1, the charge restriction resistance R2 and the rectifier diode Da, and the capacitor C1 is not charged at the time of generation of the address pulse. Accordingly, the potential of the node N7 does not rise to a predetermined value, and the transistor Q10 is not turned on. As a result, the abnormality detection signal SOS is not output because of generation of the address pulse.

As described above, the abnormal pulse can be distinguished from the normal pulse based on a difference of the rate of generation, and the abnormal pulse can be distinguished from the address pulse based on a difference of the peak value in the protection circuit 300 of the present embodiment. Accordingly, the abnormality detection signal SOS can be output at the time of detection of the abnormal pulse. Since the abnormal operation of the scan IC 100 temporarily occurs in many cases, the scan IC 100 can be restored to the normal operation by temporarily turning off the power supply circuit using the abnormality detection signal SOS and resetting the plasma display device.

### (8) The Configuration and Operation of the Protection Circuit 300

The abnormality detection signal SOS generated by the protection circuit 300 of the present embodiment can be also used as an abnormality detection signal to be generated by a voltage abnormality detection circuit that detects voltage abnormality of the DC power supply 200.

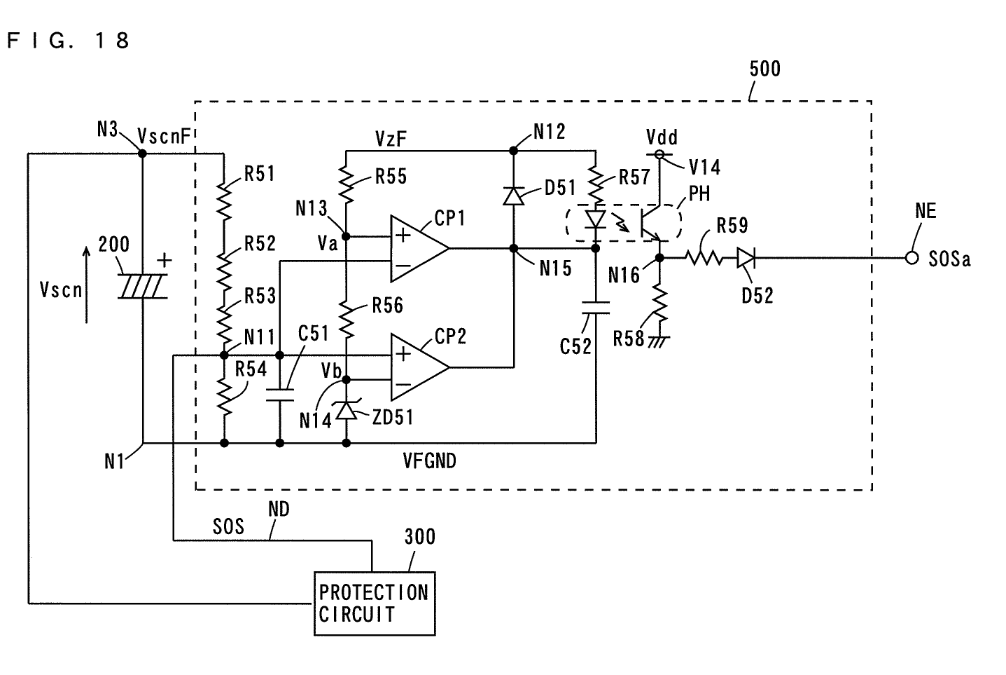

FIG. 17 is a block diagram showing the configuration of the protection circuit and the voltage abnormality detection circuit in which the abnormality detection signal is commonly used. FIG. 18 is a circuit diagram showing the configuration of the voltage abnormality detection circuit.

As shown in FIG. 17, the voltage abnormality detection circuit 500 is connected between the node N1 and the node N3. The abnormality detection signal SOS output from the node ND of the protection circuit 300 is applied to the voltage abnormality detection circuit 500. An abnormality detection signal SOSa is output from a node NE of the voltage abnormality detection circuit 500.

As shown in FIG. 18, the voltage abnormality detection circuit 500 includes resistances R51 to R59, capacitors C51, C52, zener diode ZD51, diodes D51, D52, comparators CP1, CP2 and a photocoupler PH.

The resistances R51 to R53 are connected in series between the node N3 and a node N11, and the resistance R54 is connected between the node N11 and the node N1. The capacitor C51 is connected between the node N11 and the node N1. The resistance R55 is connected between a node N12 and a node N13, and the resistance R56 is connected between the node N13 and a node N14. The zener diode ZD51 is connected between the node N14 and the node N1.

One input terminal of the comparator CP1 is connected to the node N13, and the other input terminal thereof is connected to the node N11. One input terminal of the comparator CP2 is connected to the node N11, and the other input terminal thereof is connected to the node N14. Output terminals of the comparators CP1, CP2 are connected to a node N15. The resistance R57 and a light emitting diode of the photocoupler PH are connected in series between the node N12 and the node N15. The capacitor C52 is connected between the node N15 and the node N1.

A photo transistor of the photocoupler PH is connected between a power supply terminal V14 that receives a voltage Vdd and a node N16. The resistance R58 is connected between the node N16 and the ground terminal, and the resistance R59 and the diode D52 are connected in series between the node N16 and the node NE.

As described above, the potential VscnF of the node N3 is the potential (VFGND+Vscn) that is higher than the potential VFGND of the node N1 by the voltage Vscn. In addition, a potential VzF of the node N12 is (VFGND+Vz). Here, Vz is a constant voltage. A potential Va of the node N13 is higher than a potential Vb of the node N14.

When the voltage Vscn held by the DC power supply 200 is within a normal range, the potential of the node N11 is higher than the potential Vb of the node N14 and lower than the potential Va of the node N13. This causes potentials of output terminals of the comparators CP1, CP2 to attain high levels. In this case, a current does not flow to the light emitting diode of the photocoupler PH, so that the light emitting diode does not emit light. Accordingly, the photo transistor of the photocoupler PH is not turned on. As a result, the potential of the node N16 is low, and the potential of the node NE attains a low level.

Meanwhile, when the voltage Vscn held by the DC power supply 200 is higher than an upper limit of the normal range, the potential of the node N11 is higher than the potential Va of the node N13. This causes the potential of the output terminal of the comparator CP1 to attain a low level. In this case, a current flows to the light emitting diode of the photocoupler PH, and the light emitting diode emits light. Thus, the photo transistor of the photocoupler PH is turned on. As a result, the potential of the node N16 is high, and the abnormality detection signal SOSa of high level is output from the node NE.

In addition, when the voltage Vscn generated by the DC power supply 200 is lower than a lower limit of the normal range, the potential of the node N11 is lower than the potential Vb of the node N14. This causes the potential of the output terminal of the comparator CP2 to attain a low level. In this case, a current flows through the light emitting diode of the photocoupler PH, and the light emitting diode emits light. Thus, the photo transistor of the photocoupler PH is turned on. As a result, the potential of the node N16 is high, and the abnormality detection signal SOSa of high level is output from the node NE.

Furthermore, when the abnormality detection signal SOS of high level is output to the node ND of the protection circuit 300, the potential of the node N11 is higher than the potential Va of the node N13. This causes the potential of the output terminal of the comparator CP1 to attain a low level. In this case, a current flows to the light emitting diode of the photocoupler PH, and the light emitting diode emits light. Thus, the photo transistor of the photocoupler PH is turned on. As a result, the potential of the node N16 is high, and the abnormality detection signal SOSa of high level is output from the node NE.

In this manner, the abnormality detection signal SOS of the protection circuit 300 and the abnormality detection signal SOSa of the voltage abnormality detection circuit 500 can be commonly used. This reduces the number of components and assembly steps. This results in lower cost of the plasma display device.

### (9) Other Embodiments

While the two zener diodes ZD1, ZD2 are provided in the foregoing embodiment, one zener diode may be provided when the peak value of the address pulse is low.

While the protection circuit 300 includes the zener diodes ZD1, ZD2 in the foregoing embodiment, the zener diodes ZD1, ZD2 may not be provided when the values of the capacitor C1, the charge restriction resistance R2 and the discharge resistances R3, R4 are adjusted to allow the abnormal pulse to be detected without detection of the address pulse.

Furthermore, while the two discharge resistances R3, R4 are connected between the node N3 and the node N6 in the foregoing embodiment, one discharge resistance may be connected between the node N3 and the node N6. In this case, the base of the transistor Q10 is connected to the node N6.

### (10) Correspondences Between Elements in the Claims and Parts in Embodiments

In the following paragraphs, non-limiting examples of correspondences between various elements recited in the claims below and those described above with respect to various preferred embodiments of the present invention are explained.

In the foregoing embodiment, the scan electrode driving circuit 53 is an example of a driving device, the node N1 is an example of a first node, the node N2 is an example of a second node, the scan electrode SC1 is an example of a switch circuit, the DC power supply 200 is an example of a voltage hold circuit, the transistors Q3 to Q8, the power supply terminals V11 to V13, the ground terminal and the recovery circuit 400 are examples of a voltage application circuit, and the protection circuit 300 is an example of a protection circuit.

The protective resistance R1 is an example of a protective resistance, the capacitor C1, the charge restriction resistance R2, the diode Da and the discharge resistances R3, R4 are examples of a rectification circuit, and the transistor Q10 is an example of a detection circuit or a switching element. The capacitor C1 is an example of a capacitive element, the charge restriction resistance R2 is an example of a first resistive element, the discharge resistances R3, R4 are examples of a second resistive element, the diode Da is an example of a unidirectional conductive element, and the zener diodes ZD1, ZD2 are examples of a voltage reduction circuit or a zener diode.

Furthermore, the abnormality detection signal SOS is an example of a detection signal, the abnormality detection signal SOSa is an example of a common detection signal, the power supply Vscn is an example of a first voltage, the predetermined value is an example of a first value, a zener voltage is an example of a second value, and the sustain pulse Ps is an example of a sustain pulse.

### INDUSTRIAL APPLICABILITY

The present invention is applicable to a display device that displays various images.

1. A driving device of a plasma display panel that drives the plasma display panel including a plurality of discharge cells at intersections of a plurality of scan electrodes and a plurality of sustain electrodes with a plurality of data electrodes, comprising:
a plurality of switch circuits that are provided corresponding to said plurality of scan electrodes and selectively connect either a first node or a second node to said plurality of scan electrodes;
a voltage application circuit that changes a potential of said first node;
a voltage hold circuit that holds a voltage between said first node and said second node to a first voltage; and
a protection circuit that is provided between said voltage hold circuit and said second node, wherein
said protection circuit includes
a protective resistance connected between said voltage hold circuit and said second node,
a rectification circuit that rectifies a voltage generated in said protective resistance, and
a detection circuit that detects occurrence of an abnormal operation based on the voltage rectified by said rectification circuit.

2. The driving device of the plasma display panel according to claim 1, wherein said detection circuit outputs a detection signal indicating the occurrence of the abnormal operation when the voltage rectified by said rectification circuit is higher than a first value.

3. The driving device of the plasma display panel according to claim 2, wherein
said rectification circuit includes said capacitive element, a first resistive element, a second resistive element and a unidirectional conductive element, and
said capacitive element, said first resistive element and said unidirectional conductive element are connected in series between said voltage hold circuit and said second node, said second resistive element is connected in parallel to said capacitive element, and said unidirectional conductive element allows a current to flow in one direction such that said capacitive element is charged by the voltage generated in said protective resistance.

4. The driving device of the plasma display panel according to claim 3, wherein said detection circuit includes a switching element that is turned on when the voltage rectified by said rectification circuit is higher than the first value and outputs said detection signal in response to said switching element that is turned on.

5. The driving device of the plasma display panel according to claim 3, wherein
said driving device drives said plasma display panel by a sub-field method where one field period includes a plurality of sub-fields, and each sub-field includes a write period for generating a write discharge by selectively applying a write pulse to said plurality of discharge cells and a sustain period for applying a sustain pulse to said plurality of discharge cells in order to cause the discharge cell in which said write discharge has been generated to emit light,
said plurality of switch circuits connect said first node to said plurality of scan electrodes in said sustain period,
said voltage application circuit applies the sustain pulse to said first node in said sustain period, and
said detection circuit detects an abnormal state in which said second node is connected to at least one of said plurality of scan electrodes in said sustain period based on whether the voltage rectified by said rectification circuit is not less than said first value.

6. The driving device of the plasma display panel according to claim 5, wherein
said switch circuits switch at a predetermined timing a first state in which said first node is connected to said plurality of scan electrodes to a second state in which said second node is connected to said plurality of scan electrodes, and
said first value is set lower than the voltage rectified by said rectification circuit at the time of occurrence of said abnormal state in said sustain period and is set higher than the voltage rectified by said rectification circuit at the time of switching of said first state to said second state.

7. The driving device of the plasma display panel according to claim 6, wherein at least one sub-field of said plurality of sub-fields includes a setup period in which wall charges of said plurality of discharge cells are adjusted such that the write discharge can be performed, and
said predetermined timing is within said setup period.

8. The driving device of the plasma display panel according to claim 3, wherein
said protection circuit further includes a voltage reduction circuit that applies to said rectification circuit a voltage that is lower than the voltage generated in said protective resistance by a second value.

9. The driving device of the plasma display panel according to claim 8, wherein said voltage reduction circuit includes a zener diode that is connected in series to said capacitive element, said first resistive element, said second resistive element and said unidirectional conductive element between said voltage hold circuit and said second node, and
said zener diode is connected opposite to said unidirectional conductive element and has a zener voltage that corresponds to said second value.

10. The driving device of the plasma display panel according to claim 8, wherein said plurality of switch circuits sequentially connect said first node to said plurality of scan electrodes each for a given period of time in said write period, and
said second value is set such that the voltage rectified by said rectification circuit is lower than said first value in said write period.

11. The driving device of the plasma display panel according to claim 3, further comprising:
a voltage detection circuit that detects that the voltage held by said voltage hold circuit exceeds an allowable value, wherein
said voltage detection circuit outputs a common detection signal when the voltage held by said voltage hold circuit exceeds the allowable value or when a detection signal output from the protection circuit is received.

12. A driving method of a plasma display panel including a plurality of discharge cells at intersections of a plurality of scan electrodes and a plurality of sustain electrodes with a plurality of data electrodes, comprising the steps of:
holding a voltage between a first node and a second node to a first voltage by a voltage hold circuit;
changing a potential of said first node;
selectively connecting either the first node or the second node to said plurality of scan electrodes by a plurality of switch circuits that are provided corresponding to said plurality of scan electrodes;
rectifying a voltage generated in a protective resistance connected between said voltage hold circuit and said second node; and
detecting occurrence of an abnormal operation based on said rectified voltage.

13. A plasma display device comprising:
a plasma display panel including a plurality of discharge cells at intersections of a plurality of scan electrodes and a plurality of sustain electrodes with a plurality of data electrodes; and
a driving device that drives said plurality of scan electrodes of said plasma display panel, wherein
said driving device includes
a plurality of switch circuits that are provided corresponding to said plurality of scan electrodes and selectively connect either a first node or a second node to said plurality of scan electrodes,
a voltage application circuit that changes a potential of said first node,
a voltage hold circuit that holds a voltage between said first node and said second node to a first voltage, and
a protection circuit that is provided between said voltage hold circuit and said second node, and
said protection circuit includes
a protective resistance connected between said voltage hold circuit and said second node,
a rectification circuit that rectifies a voltage generated in said protective resistance, and
a detection circuit that detects occurrence of an abnormal operation based on the voltage rectified by said rectification circuit.
